(19) United States
(12) Patent Application Publication
(10) Pub. No.: US 2007/0037115 A1
(43) Pub. Date: Feb. 15, 2007

(54) Dental model articulator

(76) Inventor: Gordon K. Sim, Palo Alto, CA (US)

Correspondence Address: Gordon K. Sim;Suite L, 3390 De La Cruz Blvd., Santa Clara, CA, 95054, US

(21) Appl. No.: 11/201,059

(22) Filed: Aug. 11, 2005

(51) Int. Cl. A61C 11/00

(52) U.S. Cl. 433/57; 433/60

(57) ABSTRACT

The articulators of the present invention provide relative manipulation of dental models for simulation of occlusal and masticatory movements of the mouth. The full arch articulator with a removable wall consists of four parts—a lower part, an upper part, a middle part, and a rear part. The lower part is comprised of a full arch box, a pair of female hinge assemblies, and an incisal guide plate. The full arch box has an open bottom and an insert at the top with a series of grooves. The upper part is comprised of a spherical inner surface, a spherically concaved area on the outer surface, a square box with an open top, a vertical support with sides of cylindrical halves, and an incisal pin hole. The middle part is snap-seated on top of the full arch box in the lower part. The rear part is comprised of a pair of extension arms to receive the upper part for connection and a male hinge bar which is connected to the lower part. The quadrant articulator with a detachable wall consists of two parts—an upper part and a lower part. The upper part is comprised of an elongated channeled surface, a deformable bracket, a snap-fit female hinge assembly, and a platform with a hole. The lower part is comprised of an elongated block with two rows of pin holes, two rows of struts, pin position indicators, a pair of model lifters, a tray positioning plate, a vertical stop pin holder, a snap-fit male hinge assembly, and a platform.

This application is for alternative embodiments of the previous invention, patent no. U.S. Pat. No. 6,402,513, Jun. 11, 2002.

### TECHNICAL FIELD

The present invention relates to dental prosthetics. More particularly, the invention relates to the method and structure for constructing dental models and for supporting the dental models in a manner which replicates normal mouth movements.

### BACKGROUND OF THE INVENTION

Devices intended to support dental models are commonly known in the industry as dental model articulators. These devices have been used for a number of years to construct removable or fixed prosthetic appliances such as dentures, crowns and bridges.

The dental appliances are constructed and adjustments are made before insertion into the patient's mouth. For example, during construction of a crown, it is desirable to study the crown for compatibility with the patient's mouth and existing teeth. To accomplish this, the dental models are mounted on a device in a manner which enables the simulation of the patient's mouth during occlusal and masticatory movement.

Inexpensive disposable articulators currently in use are disclosed in U.S. Pat. Nos. 4,196,518, 4,382,787, 4,449,930, 4,533,323, 4,548,581, and 5,482,460. These articulators incorporate lockable ball-and-socket elements and flexible hinged brackets to mount the upper and lower dental models. When the correct bite relationship is found, the ball-and-socket joints are immobilized with an adhesive. The resiliently flexible bracket and hinge permit simulation of translatory movement, multi-axis pivotal movement, a full range of occlusal and masticatory movements, and other functions. Other U.S. Patents describing articulators include U.S. Pat. Nos. 3,466,750, 4,196,518 and 4,169,314.

However, these articulators, particularly the inexpensive ones, disclosed in U.S. Pat. Nos. 4,548,581 to Huffman and U.S. Pat. No. 5,482,460 to Farnor, Jr., have several deficiencies. Once the ball-and-socket joints are fixed with an adhesive, the models cannot be dismounted. Many times remounting is required since the bite record taken in the patient's mouth is often incorrect. When the mounting is incorrect, these articulators, which do not have any means of remounting, need to be forcefully detached from the models and then be replaced for remounting. This process is cumbersome and time consuming. Another deficiency is that these articulators do not provide a vertical stop. When many teeth are missing or there are no opposing teeth to come into contact with, the upper and lower models collapse. When mounting these kinds of models with articulators that do not have built-in vertical stops, external vertical stops need to be constructed during the impression-pouring process. Another deficiency is that these devices do not provide a self-cleaning mechanism, requiring extensive model trimming and grinding. Yet another deficiency is the numerous steps involved, requiring extensive model work.

One type of disposable articulator on the market today is wall-less. Another type has a fixed wall. The present invention is a removable-wall type. The removability is a key feature that makes it possible to implement all the functions and advantages found in the fixed-wall and wall-less articulators. Another key feature of the present invention is a tray positioning plate. The tray positioning plate makes pin placement more accurate by eliminating the process of marking the position of the impression tray relative to the articulator.

The two features described above are unique to the present invention and are essential features that separate them from conventional articulators. The removable/detachable wall and the tray positioning plate are proprietary designs requiring patent protection.

### SUMMARY OF THE INVENTION

The present invention provides relative manipulation of dental models through full orbital and masticatory ranges wherein every phase and condition of dental occlusive relationships can be accurately portrayed and duplicated. The inexpensive disposable articulator of the present invention was made possible by the built-in design and novel features which eliminate many steps and manual operations, increasing both productivity and quality dramatically.

The removable/detachable wall structure allows for combining the fixed-wall and wall-less systems. By the ‘two-in-one’ design of the present invention, all shortcomings associated with dental model articulators were resolved.

The tray positioning plate unique to the present invention makes it possible to place the pins without marking the position on the impression tray and the articulator. More importantly, it permits the user to pour the die-side of the impression first. With other articulators, due to errors caused by the manual mark-and-place method of pin placement, the opposing side of the impression is poured first. Pouring the opposing side first is technically unacceptable as the impression becomes distorted due to the expansion of the die stone. This deficiency was resolved by the tray positioning plate in the present invention.

Some of the embodiments of the present invention are:

A full arch articulator with a removable wall but without a tray positioning plate (FIG. 1),

A full arch articulator with a detachable wall and a tray positioning plate (FIG. 11),

A full arch articulator with a fixed wall and a tray positioning plate (FIG. 23),

A quadrant articulator with a detachable wall and a tray positioning plate (FIG. 18),

A quadrant articulator with a fixed wall and a tray positioning plate (FIG. 24), and

A quadrant articulator with a removable wall and a tray positioning plate (FIG. 25).

The full arch articulator with a removable wall consists of four sub-assemblies—a lower part (FIG. 1d), an upper part (FIG. 1a), a middle part (FIG. 1b), and a rear part (FIG. 1c).

The lower part is for mounting the lower dental model in which the teeth under restoration reside.

The upper part is for mounting the opposing dental model.

The middle part is for forming the dental model, removing any excess dental stone, and increasing the dental model thickness by the height of the part.

The rear part interconnects the upper and lower parts indirectly.

The lower part has a pair of hinge assemblies structured in resemblance of the condylar region of the temporomandibular joints. The hinges are designed with a horizontal condylar guide and a lateral condylar guide. The inclination of the horizontal condylar guide is set at 40 degrees. The inclination of the lateral condylar guide is set at 17 degrees. The condylar guides are set for 1.0 mm side shift. These condylar guides permit the dental models to make the rotary and translatory movements at a predetermined inclination.

The full arch articulator with a detachable wall consists of three sub-assemblies—a lower part (FIG. 11c), an upper part (FIG. 11a), and a rear part (FIG. 11b).

The lower part is for mounting the lower dental model in which the teeth under restoration reside.

The upper part is for mounting the opposing dental model.

The rear part interconnects the upper and lower parts indirectly.

The full arch articulator with a fixed wall consists of three sub-assemblies—a lower part (FIG. 23), an upper part (FIG. 11a), and a rear part (FIG. 11b).

The lower part is for mounting the lower dental model in which the teeth under restoration reside.

The upper and lower parts are identical to those described above.

The quadrant articulator with a detachable wall consists of two sub-assemblies—a lower part (FIG. 18b) and an upper part (FIG. 18a).

The lower part is for mounting the lower dental model in which the teeth under restoration reside.

The upper part is for mounting the opposing dental model.

The quadrant articulator with a fixed wall consists of two sub-assemblies—a lower part (FIG. 24) and an upper part (FIG. 18a).

The lower part is for mounting the lower dental model in which the teeth under restoration reside.

The upper part is for mounting the opposing dental model.

The quadrant articulator with a removable wall consists of thee sub-assemblies—a lower part (FIG. 25b), a middle part (FIG. 25a), and an upper part (FIG. 18a).

The lower part is for mounting the lower dental model in which the teeth under restoration reside.

The middle part is for forming the dental model, removing any excess dental stone, and increasing the dental model thickness by the height of the part.

The upper part is for mounting the opposing dental model.

By the noble features of a detachable wall and a tray positioning plate, the present invention yields superior model work with regards to quality, accuracy, workmanship and productivity.

Important requirements of a disposable articulator include cost, productivity, quality and versatility.

Accordingly, the primary objective of the present invention is to provide an improved disposable articulator.

Another objective of the present invention is to accommodate all single-sided or double-sided quadrant-arch, half-arch, or full arch impression trays.

Still another objective of the present invention is to incorporate fixed condylar guides to simulate the movement of the mandibular jaw.

A further objective of the present invention is to provide a means of adjusting the vertical height.

Yet a further objective of the present invention is to reduce working time, therefore increasing productivity.

Still a further objective of the present invention is to provide an articulator with a self-cleaning mechanism which eliminates the need for model trimming and grinding, dramatically increasing productivity.

An additional objective of the present invention is to provide an articulator that yields accuracy of the crowns.

Another objective of the present invention is to yield quality workmanship and aesthetics.

Still another objective of the present invention is to provide an articulator which automatically grooves on the bottom of the dental model, eliminating the need for hand-grooving.

A further objective of the present invention is to provide an articulator which automatically exposes the pins.

Still a further objective of the present invention is to provide an articulator which is simple, inexpensive and disposable.

### BRIEF DESCRIPTION OF THE DRAWINGS

The features and advantages of the present invention may be observed with greater clarity in the following drawings, in which:

FIGS. 1a-1d are top perspective views of sub-assemblies of a full arch articulator with a removable wall but without a tray positioning plate;

FIG. 2 is a top perspective view of an assembled full arch articulator of the sub-assemblies shown in FIGS. 1a-1d;

FIGS. 3-7 are step-by-step procedures showing how to construct a lower dental model;

FIGS. 8 and 9 show how to construct an upper dental model;

FIG. 10 is a side view of a completed dental model work on a full arch articulator;

FIGS. 11a-11c are top perspective views of sub-assemblies of a full arch articulator with a detachable wall and a tray positioning plate;

FIG. 12 is a top perspective view of an assembled full arch articulator of the sub-assemblies shown in FIGS. 11a-11c;

FIGS. 13-16 are step-by-step procedures showing how to construct a lower dental model;

FIG. 17 is a side view of a completed dental model work on a full arch articulator of the present invention;

FIGS. 18a and 18b are top perspective views of sub-assemblies of a quadrant articulator with a detachable wall and a tray positioning plate;

FIG. 19 is a top perspective view of an assembled quadrant articulator of the sub-assemblies shown in

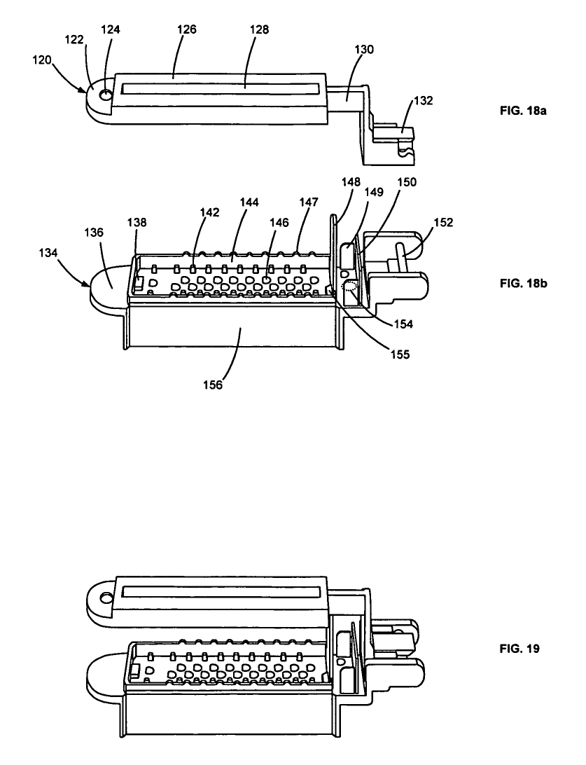

FIGS. 18a and 18b;

FIGS. 20-22 are step-by-step procedures showing how to complete a dental model work on a quadrant articulator of the present invention;

FIG. 23 is a top perspective view of a full arch articulator with a fixed wall and a tray positioning plate;

FIG. 24 is a top perspective view of a quadrant articulator with a fixed wall and a tray positioning plate;

FIGS. 25a and 25b are top perspective views of sub-assemblies of a quadrant articulator with a removable wall and a tray positioning plate;

FIG. 26 is a top perspective view of an assembled quadrant articulator of the sub-assemblies shown in FIGS. 25a and 25b;

FIG. 27 is a top perspective view of an anterior arch articulator;

FIG. 28 is a top view of a custom-made fixture for determining pin holes; and

FIG. 29 is a side view of a custom-made fixture for determining pin holes.

### DETAILED DESCRIPTION OF THE PREFERRED EMBODIMENTS

As used herein, the term ‘occlusal movement’ shall refer generally to movement of the model which brings the opposing surfaces of the teeth of the two jaws into contact from a spread-apart position, whereas the term ‘occlusion’ refers to the position of the teeth when the opposing surfaces of the teeth are in contact with one another in proper position for bite registry. The term ‘masticatory movement’ shall refer generally to a motion which is the combination of vertical, horizontal and/or side-to-side movement of the teeth and jaws such as occurs when chewing with at least a portion of the upper teeth in contact with at least a portion of the lower teeth.

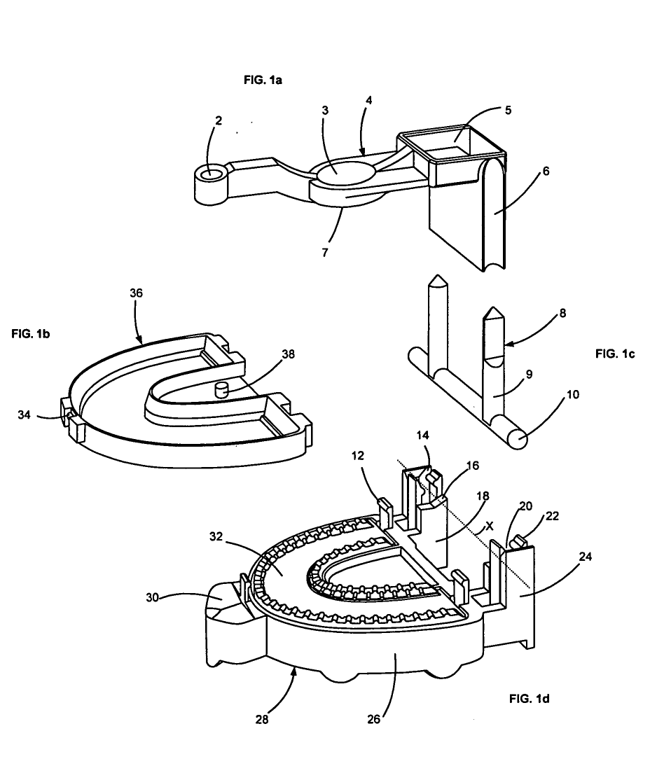

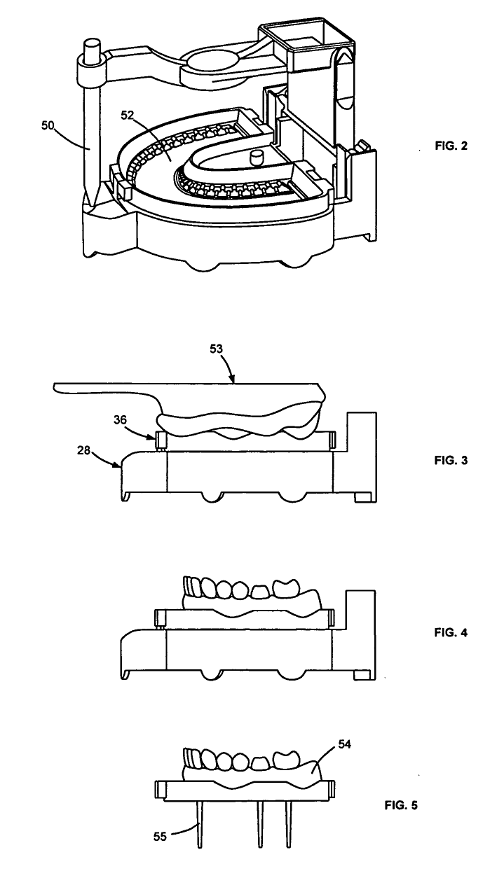

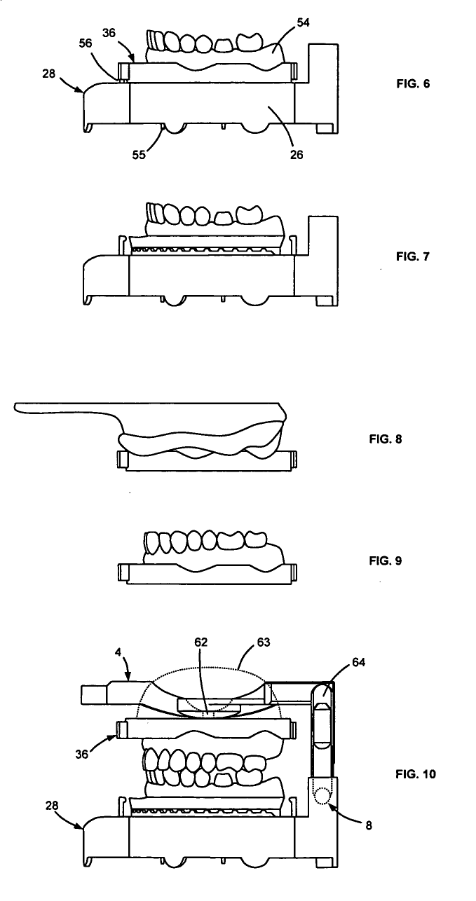

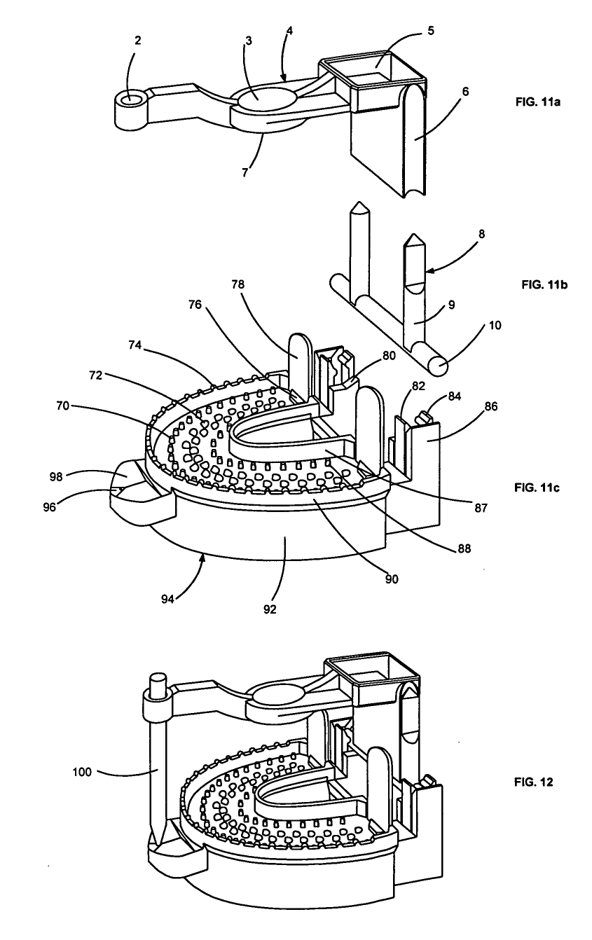

Referring jointly to FIGS. 1a, 1b, 1c and 1d, the full arch articulator with a removable wall but without a tray positioning plate consists of four parts—lower part 28 (FIG. 1d), upper part 4 (FIG. 1a), middle part 36 (FIG. 1b), and rear part 8 (FIG. 1c). The upper part 4 and the lower part 28 are indirectly connected through the rear part 8. The rear part 8 provides a male hinge bar 10 which connects to the lower part 28 and a pair of extension arms 9 which connects to the upper part 4. FIG. 2 shows an assembled full arch articulator of the present invention.

The upper part 4 is comprised of a spherically concaved area 3 to receive plaster, a square box 5 to receive dental stone, a vertical support 6, and an incisal pin holder 2. The upper part 4 holds the upper dental model.

The middle part 36 is snap-seated on top of the lower part 28. Three retentive circular arms 34 at the cutouts on the middle part 36 mate with three retentive latches 12 on the lower part 28. The cylindrical post 38 holds the stone in place as it can be seen in FIG. 8.

The rear part 8 is comprised of a pair of height extension arms 9 and a male hinge bar 10. The upper part 4 is inserted into the extension arms 9 adjusting itself to the height of the models. The male hinge bar 10 snap-seats in the hinge assemblies (14,16,20,22) of the lower part 28.

The lower part 28 is comprised of a full arch box 26, a grooved insert 32, three retentive latches 12, an incisal guide plate 30, and a pair of snap-fit female hinge assemblies 20. The lower part 28 houses the dental model on which the teeth under restoration reside.

The full arch box 26 in the lower part 28 has an open bottom and a detachable top insert 32. The size of the full arch box 26 is that of a typical impression tray.

The top surface of the insert 32 of the full arch box 26 bears two rows of grooved patterns which are imprinted on the bottom of the model when the dental stone is poured onto it. With these imprints, dies (cut sections of the dental model) can be brought to their original positions, and dies can remain seated stably. The top insert 32 is raised slightly higher than the rim of the full arch box 26 and the dimensions of the insert 32 are same as the inner dimensions of the middle part 36. This embodiment permits the middle part 36 to be seated around the insert 32 in a wrapping fashion, forming a top full arch box 52 (FIG. 2) into which the dental stone can be poured. The top full arch box 52 serves as a mold, producing uniquely sized models with consistent quality and accuracy. By use of the insert 32 with grooved patterns, the need to make grooves by hand is eliminated. The insert 32 is held to the full arch box 26 and made detachable from the full arch box 26 by depressing the front end of the insert 32 with one's fingers.

The depth at the middle of the full arch box 26 is slightly less than the length of the pins 55 (FIG. 5) commonly used in the industry. This embodiment allows for the tips of the pins 55 (FIG. 6) to be exposed when the dental stone is poured into the box. This embodiment eliminates the need to dig up the stone with an instrument to expose the pins. The height of the full arch box 26 is slightly longer than the pins 55 so that when the articulator is on the work bench, the pins 55 are secured from the work surface.

Around the full arch box 26, three male latches 12 are provided for the middle part 36 to be firmly seated around the insert 32.

The incisal guide plate 30 serves as a stop for the incisal pin placed in the hole 2 of the upper part 4. The incisal guide plate 30 is V-shaped in such a way that the movement of the upper model follows the V shape, simulating the movement of the mandibular jaw. The incisal pin maintains the vertical height of the upper and lower models.

A pair of female hinge assemblies 20 are attached to the rear of the full arch box 26. Each hinge assembly 20 is comprised of three functional elements: an inner wall 18, a pair of resiliently flexing, firm hinges 22, and an outer wall 24. The top surface of the inner wall 18 is cut at two different slopes. The flat horizontal surface defines a stop for the rear part 8. The sloped surface 16 guides the upper part male hinge bar 10 to travel along the slope, which simulates the movement of the mandibular jaw as the upper model moves to the rear. This slope represents the horizontal condylar inclination which simulates the contour of the mandibular fossa of the temporal bone. The outer wall 24 is horizontally V-shaped 14. This angulation permits the upper part male hinge bar 10 to be pulled to the left or right as the upper model moves toward the rear. This angulation represents the lateral condylar inclination which simulates the lateral shift of the mandible. Together, the inner wall 18, outer wall 24, and the incisal guide plate 30 can simulate the masticatory movement at a predetermined inclination.

The upper part 4 provides four major functions. At the front end is a cylindrical hole 2 where an incisal pin 50 (FIG. 2) can be mounted. In the middle of the upper part 4 is a spherically concaved area 3 which receives the plaster when mounting the dental model. At the center of the spherically concaved area 3 is a hole 62 (FIG. 10) into which an adhesive is applied to attach the dental model to the bottom 7 (FIG. 1a) of the upper part 4. The upper part 4 has a spherical area 7 on the inner surface so that a tilted model can be adapted closely. The squarely box 5 may be filled with a colored gypsum for improved aesthetics and increased rigidity. The sides of the vertical support 6 are cylindrical in shape and can be drop-inserted between the extension arms 9 of the rear part 8 for connection with an adhesive.

The middle part 36 is snap-seated on top of the lower part 28. Three retentive circular arms 34 on the middle part 36 mate with three latches 12 on the lower part 28. The inner dimensions of the middle part 36 are equal to the dimensions of the insert 32 on the lower part 28, hence, when seated, a full arch box 52 (FIG. 2) is formed. When pouring the impression, this box 52 is filled with the dental stone and the impression tray is placed on top of the box 52, with all spaces in between filled with stone (FIG. 3).

The middle part 36 serves two additional functions. It serves as a cleaning device and guarantees minimum die thickness. Upon completion of the model work, the middle part 36 is reused in pouring the upper model. The removal of the middle part 36 breaks off and removes all excess stone, making it unnecessary to trim the model on a model trimmer or grind off excess stone. As a guarantee of die thickness, the height of the part 36 becomes an added thickness to the model. This feature is important, especially when the depth of the impression is very shallow. If a shallow impression is poured on a flat surface without the middle part 36, the model will become so thin that it may result in accidental breakage or become difficult to work with.

FIGS. 3-10 are step-by-step procedures showing how to use the full arch articulator of the present invention.

Referring to FIG. 3, the impression tray 53 is filled with the dental stone and placed upside down on top of the middle part 36. Some time is allowed for the stone to set.

In FIG. 4, the impression tray is removed and the lower dental model is formed.

In FIGS. 4 and 5, the middle part with the dental model is separated from the lower part with the fingers, necessary holes are made on the bottom surface of the dental model 54, and pins 55 are placed with an adhesive. A separating medium is applied on the bottom surface of the dental model 54 so that the stone poured upon it will not stick to the surface.

Referring now to FIG. 6, the top insert 32 (FIG. 1d) of the lower part 28 is detached by pressing the front end of the insert 32 with the fingers. The pinned dental model 54, still surrounded by the middle part 36 is returned to the top of the lower part 28. The top side of the full arch box 26 of the lower part 28 is now sealed by the dental model 54 and the middle part 36. To form a base for the pinned dental model 54, the stone mix is poured into the full arch box 26 from the open-bottom side while holding the lower part 28 upside down. Some time is allowed for the stone to set.

Still referring to FIG. 6, the dental model 54 surrounded by the middle part 36 is removed from the lower part 28 by lifting up the bottom of the front and rear ends 56 of the middle part 36 with a flat-head screwdriver. Now the middle part 36 is removed from the dental model 54 with the fingers. The removed middle part 36 is saved to use in constructing the upper dental model.

Referring now to FIG. 7, the impression has been poured and the lower dental model is formed. The dental model can be further prepared for die work.

FIGS. 8 and 9 show how to construct an upper dental model.

Referring to FIG. 8, the dental stone is mixed and poured into the middle part and the impression tray. Then the impression tray is placed upside down on top of the middle part. Some time is allowed for the stone to set.

In FIG. 9, the impression tray is removed and the upper dental model is formed.

FIG. 10 shows how to mount the upper and lower dental models to the present articulator. The upper dental model which was formed in previous steps FIGS. 8 and 9 is placed over the lower dental model which was formed in previous steps FIGS. 3-7. While holding the upper and lower models together with one hand, the rear part 8 shown in dotted lines is connected to the lower part 28 and the upper part 4 is drop connected to the rear part 8. The spherical bottom area of the upper part 4 comes in contact with the bottom surface of the upper dental model. At this time an adhesive is applied to the hole 62 to hold the upper part 4 and the upper dental model together. Also an adhesive is applied in the space 64 between the upper part 4 and the rear part 8 for a permanent connection. The plaster 63 is placed over the spherical concave area and the upper model. The upper and lower models are mounted and the model work is completed. The mounted models may now be used to fabricate and evaluate the crown in a realistic environment for occlusal and masticatory movements of the mouth.

Referring now jointly to FIGS. 11a, 11b, 11c and 12, the full arch articulator with a detachable wall and a tray positioning plate consists of three subassemblies—lower part 94 (FIG. 11 c), upper part 4 (FIG. 11a), and rear part 8 (FIG. 11b). The lower part 94 houses the dental model on which the teeth under restoration reside. The upper part 4 and the rear part 8 are identical to those parts described above and shown in FIGS. 1a and 1c. FIG. 12 shows an assembled full arch articulator.

The lower part 28 is comprised of two rows of pin holes 72, two rows of struts (70,88), surrounding walls (87,90), a pair of tray positioning plates 78, a pair of snap-fit female hinge assemblies (82,84), an incisal guide plate (96,98).

Two rows of pin holes 72 are provided in a horse-shoe shape block. Industry standard dowel pins are placed in the holes to hold the cut sections of the model. The depth of the pin holes is slightly less than the length of the dowel pins. This embodiment allows for the tips of the pins 55 (FIG. 6) to be exposed at the bottom. The height of the lower part is slightly longer than the pins 55 so that when the articulator is on the work bench, the pins 55 are secured from the work surface.

The two rows of struts (70,88) along the pin holes serve as die stabilizers. The dies (cut sections of the dental model) can be brought to their original positions and dies can remain seated stably, preventing the die rotation or sway.

The surrounding walls consist of an outer wall 90, an inner wall 87, and a pair of rear walls containing the tray positioning plates 78. The surrounding walls form a full arch box 52 (FIG. 2) into which the dental stone can be poured. The walls are attached to the body by a thin film such that the walls can be detached with one's fingers. The top side of the outer wall has pin number indicator bumps 74, each bump indicating the number and location of a pin hole. The full arch box 52 serves as a mold, producing uniquely sized models with consistent quality and accuracy. Additionally, the walls (87,90) serve as a cleaning device and guarantee minimum die thickness. The removal of the walls (87,90) breaks off and removes all excess stone, making it unnecessary to trim the model on a model trimmer or grind off excess stone. As a guarantee of die thickness, the height of the walls becomes an added thickness to the model. This feature is important, especially when the depth of the impression is very shallow. If a shallow impression is poured on a flat surface without the walls, the model will become so thin that it may result in accidental breakage or become difficult to work with.

A pair of tray positioning plates 78 is provided at the tray-end location. Before pouring the impression, the impression tray 108 (FIG. 14) is placed against the plates 78 and the needed pin hole locations are determined. After the pins are placed at the desired locations, the impression is poured and placed upside down against the plates 78 (FIG. 14). In this process, the tray positioning plates make it possible to return the tray to the original position accurately. Since articulators on the market today are not equipped with such plates, it is necessary to mark the original position of the tray manually with a marker. The process of returning the tray to the original position using the color marks is slow, difficult and inaccurate. Often, stone which has overflowed hides the marks. Furthermore, since the pin holes in the lower anterior region are closer together, a slight error in re-positioning the tray can cause a misalignment of the pins and dies, which creates serious problems. Because of these difficulties, some of the full arch articulators in the market require that one pour the opposing side of the impression first, which is an unacceptable practice, as the stone expands while it sets and causes a distortion of the impression. The tray positioning plates in the present invention solve the distortion problem by allowing one to pour the impression die-side first.

The tray positioning plates are about the same height as the impression trays. The plates, which are part of the wall, are removed upon pouring the impression, making the articulator wall-less.

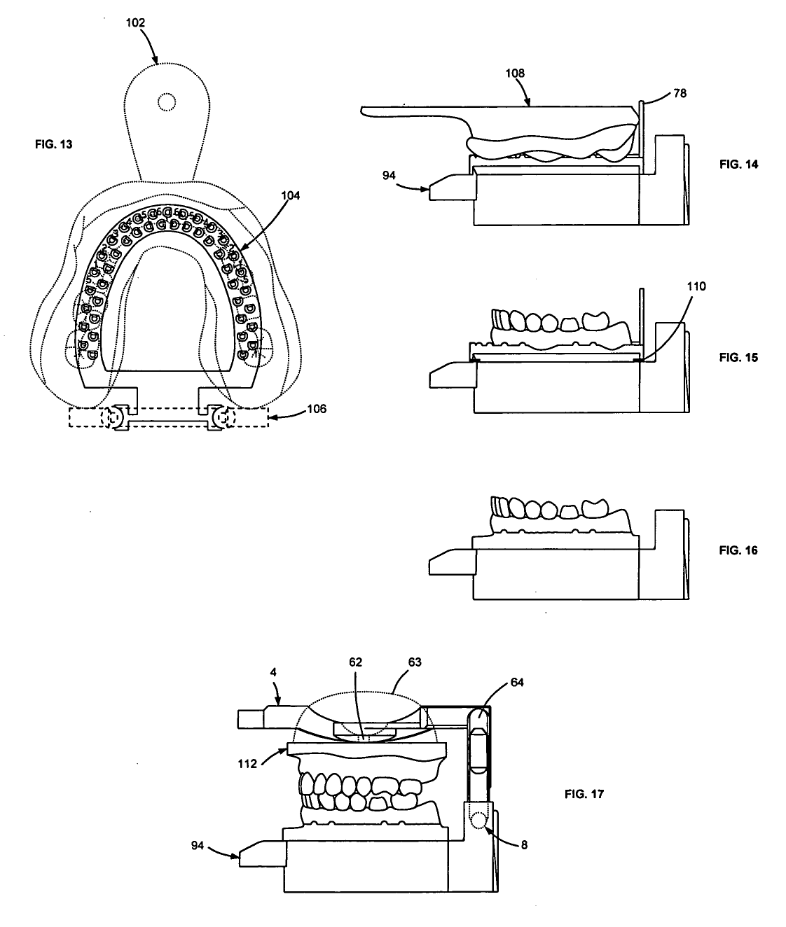

FIGS. 13-17 are step-by-step procedures showing how to use the full arch articulator.

FIG. 13 shows a custom-made pin placement fixture 104 placed over an impression tray 102. The fixture is attached to the lower part 106 of a full arch articulator and used to determine the desired pin hole locations.

Referring to FIG. 14, after placing the die pins as determined by the pin placement fixture, the impression tray 108 is filled with dental stone and placed upside down against the tray positioning plates 78 on the articulator. Some time is allowed for the stone to set.

In FIG. 15, the impression tray is removed and the lower dental model is formed. The tray positioning plates and the walls are detached by cutting horizontally along the solid lines 110 at the front and rear ends of the wall. A screwdriver access slot 76 (FIG. 11 c) at the front and at each rear end is created when the walls are cut and removed. Now the dental model can be removed from the lower part using a flat-head screwdriver.

FIG. 16 shows a lower dental model on an articulator with all walls detached.

An upper dental model is constructed as shown in FIGS. 8 and 9.

Referring to FIG. 17, the upper and lower models are mounted and the model work is completed.

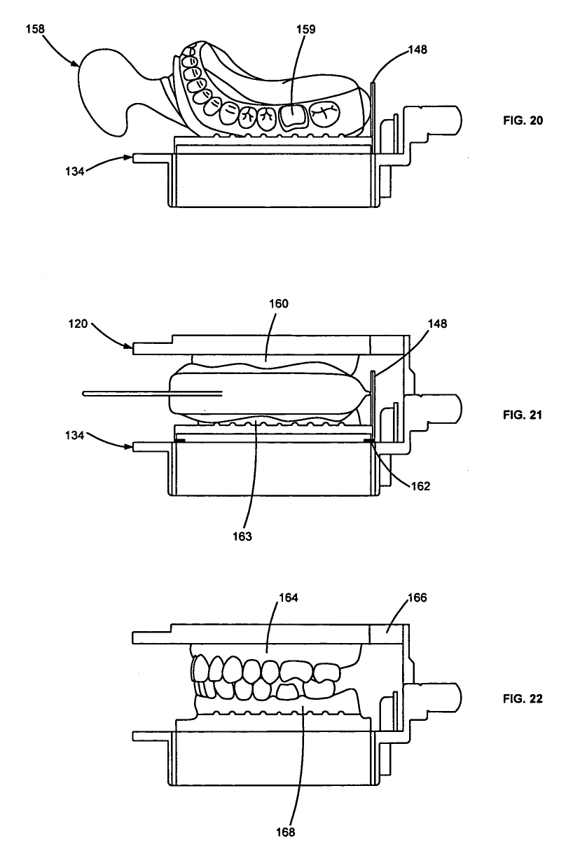

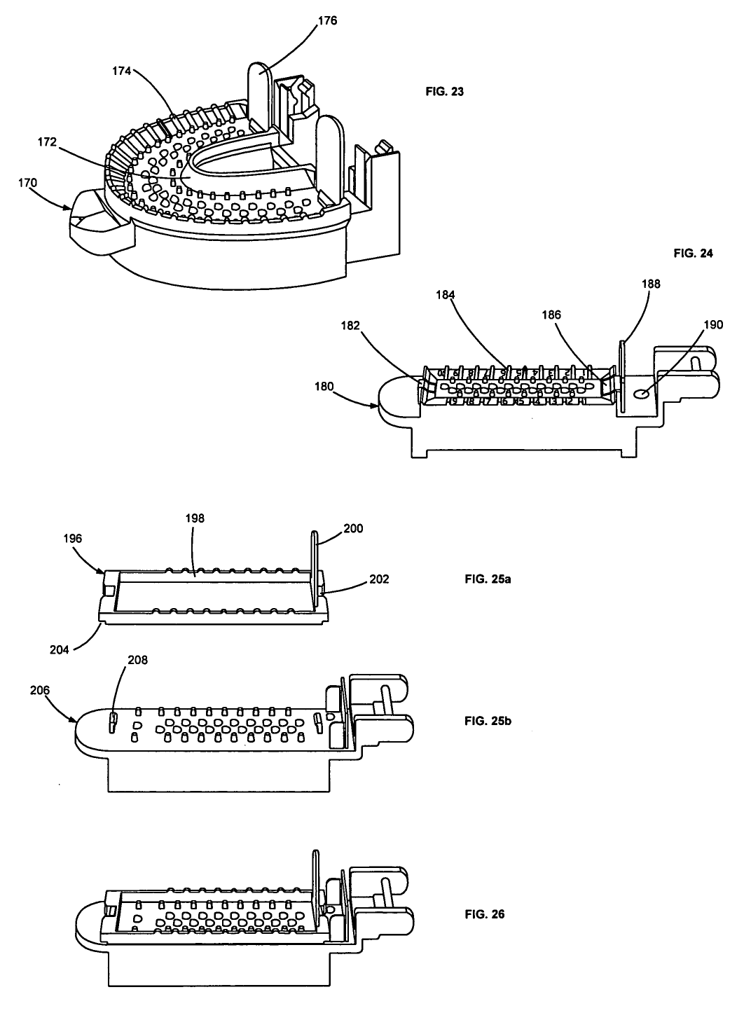

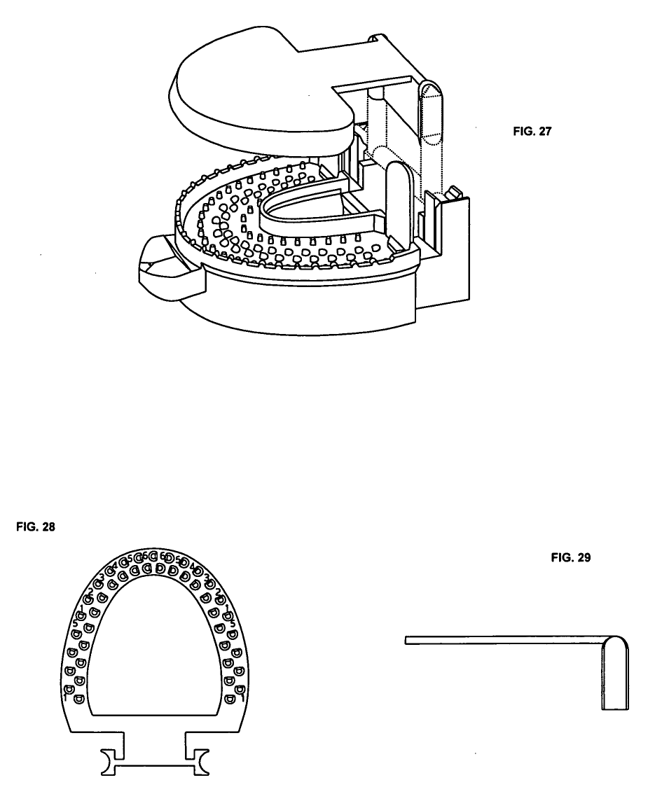

Referring now jointly to FIGS. 18a, 18b and 19, the quadrant articulator with a detachable wall and a tray positioning plate consists of two subassemblies—upper part 120 and lower part 134. The upper and lower parts are interconnected by snap-fit hinges (132,152) which produce a pivotal movement around the pivot axis.

The upper part 120 is comprised of an elongated channeled surface 126, a resiliently deformable bracket 130, a snap-fit female hinge assembly 132, and a platform 122 with a hole 124. The upper part 120 holds the opposing model 164 (FIG. 22).

The lower part 134 is comprised of an elongated block 156 with two rows of pin holes 146, two rows of struts 142, A surrounding detachable wall 144, a tray positioning plate 148, a hidden hole 154 serving as a vertical stop pin holder, a building block (148,149,150) for a stone vertical stop, a snap-fit male hinge assembly 152, and a platform 136 at the front end. The lower part 134 houses the master model 168 (FIG. 22) on which the teeth under restoration reside.

The upper and lower parts are connected by their hinges by inserting the rod 152 (FIG. 18b) on the lower part 134 to the opening of the female hinge assembly 132 (FIG. 18a) on the upper part 120.

Referring to FIG. 18b, the building block (148,149,150) for a stone vertical stop is comprised of four walls: a rear wall 150, two side walls 149, and the rear surface of the tray positioning plate 148 which serves as a front wall. A hidden pin hole 154 and a strut are provided. A stone vertical stop is used to capture the patient's bite precisely even when there is no occluding tooth. A stone vertical stop is constructed by filling the building block with the stone to the height of the walls at the time the lower model is poured and then, after the stone is set, pouring over the stone block at the time the opposing model is poured. The rear wall 150 is cut and removed and the side walls 149 are broken off.

The platform 136 at the front end of the lower part 156 serves as a stop for the vertical stop pin mounted at the front end of the upper part.

The platform 122 (FIG. 18a) attached at the front end of the upper part 120 has a hole. A plastic bar can be dropped through the hole 124 until it reaches the platform 136 of the lower part 134. At this time, the adhesive can be applied to the hole to hold the plastic bar firmly in place. The plastic bar serves as a vertical height maintainer (or a vertical stop). In the same manner, a rear vertical stop may be mounted by dropping a plastic bar through the hole 154 (FIG. 18b) until it reaches the bottom surface of the bracket 130 (FIG. 18a).

When the bite relationship of the mounted models (164, 168) (FIG. 22) is not correct, a remounting process becomes necessary. For this purpose, a bracket 166 (FIG. 22) is attached at the rear end of the upper part. The bracket 166 can be heated with a heat source. When the bracket 166 softens, the upper part is free to move about and the correct bite relationship can be found. At this time the heated bracket can be cooled and hardened to complete the remounting process.

A further description of the upper part 120 can be found in the patent no. U.S. Pat. No. 6,402,513, Jun. 11, 2002.

FIGS. 20-22 are step-by-step procedures showing how to use the quadrant articulator of the present invention.

Referring to FIG. 20, the impression tray 158 is placed over the top of the lower part 134 such that the tray-end touches the tray positioning plate 148. Then the desired pin holes for the tooth 159 under restoration and the adjacent teeth are determined and the die pins are inserted. In the figure, pin hole #4 can be chosen for the tooth 159.

Referring to FIG. 21, the lower (die) side of the impression tray and the box formed by the surrounding walls are filled with the dental stone 163 and the tray is placed on top of the lower part 134. Some time is allowed for the stone to set. After the stone is set, the opposing (upper) side of the impression tray is filled with the dental stone 160 and the upper part 120 is closed. Some time is allowed for the stone to set and the impression tray is removed.

Referring jointly to FIGS. 21 and 22, the impression tray is removed and the upper and lower models are formed and mounted. The tray positioning plate 148 and the walls are detached by cutting horizontally along the solid lines 162 at the front and rear end of the wall. Two screwdriver access slots (138,155) (FIG. 18b) are formed when the walls are cut and removed. Now the dental model can be removed from the lower part with a flat-head screwdriver. The dental model can be further prepared for die work.

Referring to FIG. 22, the upper and lower models are mounted and the model work is completed.

Referring now to FIG. 23, the structure of the full arch articulator with fixed walls (174,172) and tray positioning plates 176 is similar to the full arch articulator with a detachable wall and a tray positioning plate (FIG. 11c). The main difference between the two is that the walls are fixed and not detachable. The walls (174,172) are slanted inwards about 45 degrees. The slanted walls yield the advantages found in both the wall system and the wall-less system.

The walls consist of an outer wall 174, an inner wall 172, and a pair of rear walls which contain the tray positioning plates 176. The outer wall is slotted, one slot per pin hole. The slots serve as pin position indicators and die stablizers.

When the tray positioning plates 176 are cut and removed, screwdriver access slots are created and the dental model can be removed from the lower part.

Referring to FIG. 24, the quadrant articulator with a fixed wall 184 and a tray positioning plate 188 is the quadrant version of the full arch articulator shown in FIG. 23. The parts (182,186), when cut out, create a space for screwdriver access so that the model can be removed.

Referring now to FIGS. 25a, 25b and 26, the quadrant articulator with a removable wall 198 and a tray positioning plate 200 consists of three subassemblies—a lower part 206, a middle part 196, and an upper part 120 (FIG. 18a). The upper part is made common to all quadrant articulators of the present invention. The detachable walls 144 (FIG. 18b) in the quadrant articulators described in the previous sections are made as a separate piece, called the middle part 196. The middle part is assembled to the lower part before the stone is poured. When assembled, the wall is now removable rather than detachable yet the overall functions remain unchanged. An assembled quadrant articulator is shown in FIG. 26.

FIG. 27 shows an anterior arch articulator. An anterior arch articulator can be constructed by substituting the upper part of any full arch articulator with an anterior arch upper part shown in FIG. 27.

Referring to FIGS. 13, 28 and 29, a pin placement guide is constructed. FIG. 28 is the top view and FIG. 29 is the side view of the guide. The guide is thin and narrow so that it can be placed over an impression tray to read the pin hole numbers and place the dowel pins commonly used in the industry.

While particular constructions of the present invention are illustrated and described, the constructions are subject to modifications, substitutions and rearrangements without departing from the spirit and scope of the invention. It is, therefore, not desired to restrict the invention to the particular forms of construction illustrated and described, but to cover all modifications, substitutions, and rearrangements that may fall within the sprit and scope of the present invention, as set forth in the appended claims.

What is claimed is:

1. An articulator with a removable wall but without a tray positioning plate, consisting of four parts—lower part, upper part, middle part, and rear part, for correlating the upper and lower dental models corresponding to the upper and lower sets of a patient's teeth in a desired occlusal relationship for the simulation of occlusal and masticatory movements by application of force to the dental models, the said articulator comprising:
(a) a lower part comprising a full arch box with an open bottom;
(b) a top insert detachably supported on the lower part;
(c) an incisal guide plate extending from one end of the lower part;
(d) a pair of hinge assemblies extending from the opposite end of the lower part and incorporating the horizontal and lateral condylar guides;
(e) an upper part comprising a spherical inner surface;
(f) a spherically concaved area with a hole at the center and a box with an open top;
(g) a vertical support with half cylindrical sides extending down from one end of said upper part;
(h) an incisal pin hole at the opposite end of said upper part;
(i) a middle part having inner and outer peripheries, the inner peripheral dimensions of said middle part matching those of said detachable top insert supported on the lower part so that said part fits around said detachable top insert for sealing the top border of said part being knife-edged to facilitate a cutting effect;
(j) retentive latches on said middle and lower parts;
(k) a rear part having a pair of extension arms; and
(l) a cylindrical bar perpendicular to the extension arms.

2. The articulator of claim 1, wherein the detachable top insert supported on the lower part is provided with a series of grooves adjacent opposite peripheral edges of said top insert at an elevated level wherein the patterns of said series of grooves are impressed into the bottom of the model when the dental stone is poured and allowed to harden.

3. The articulator of claim 1, wherein said male hinge assembly includes a rod extending transverse to said lower part and forms a pivotal axis enabling selective relative pivotal displacement of said upper and lower parts.

4. The articulator of claim 1, wherein the spherical inner surface of the upper part allows tilted dental models to be adapted closely.

5. The method of modeling dental impressions in stone and mounting said dental models in an articulator to correlate the models throughout a full range of occlusal and masticatory movement, said method consisting of the sequential steps of:
(a) assembling an articulator by seating a middle part on top of the lower part;
(b) mixing the dental stone, pouring the stone into the middle part and the impression tray, and placing the impression tray upside down on top of the middle part and allowing the model stone to harden, whereupon the impression tray is removed and a lower dental model is formed;
(c) removing the middle part and the dental model together from the lower part by lifting the bottom ends of the middle part;
(d) forming holes in the bottom surface of the dental model and selectively securing pins therein;
(e) applying a separating medium on the bottom of the dental model;
(f) detaching the top insert of the lower part;
(g) returning the middle part and the dental model together to their original positions on the lower part;
(h) mixing the dental stone and applying the stone to fill the lower part to form a base;
(i) separating the middle part and the dental model together from the base in the lower part by lifting up the bottom of the front and rear ends of the middle part with a flat-head screwdriver;
(j) removing the middle part from the dental model with the fingers;
(k) returning the dental model to its original base in the lower part;
(l) mixing the dental stone, applying the stone to fill the middle part and the opposing impression tray, and placing the impression tray upside down on top of the middle part and allowing the model stone to harden, whereupon the impression tray is removed and an upper dental model is formed;
(m) placing the upper dental model on the lower dental model in proper occlusion;
(n) connecting a rear part to the lower part with the dental model by pivotally joining them together;
(o) drop inserting an upper part to the rear part and fixing with an adhesive;
(p) applying an adhesive to the hole at the center of the spherical concave of the upper part to attach the upper dental model to the upper part; and
(q) mixing and applying the plaster over the upper dental model and the upper part and allowing the plaster to harden, whereupon the model work is completed.

6. An articulator with a detachable wall and a tray positioning plate for correlating the upper and lower dental models corresponding to the upper and lower sets of a patient's teeth, the said articulator comprising:
(a) a lower part comprising a full arch box with an open bottom;
(b) a horse-shoe shape block with embedded pin holes housed in the middle of the lower part;
(c) a pair of tray positioning plates at the rear end of the full arch box of the lower part;
(d) a surrounding wall detachably attached to the full arch box of the lower part;
(e) two rows of struts along the wall;
(f) an incisal guide plate extending from one end of the lower part;
(g) a pair of hinge assemblies extending from the opposite end of the lower part and incorporating the horizontal and lateral condylar guides;
(h) an upper part comprising a spherical inner surface;
(i) a spherically concaved area with a hole at the center and a box with an open top;
(j) a vertical support with half cylindrical sides extending down from one end of said upper part;
(k) an incisal pin hole at the opposite end of said upper part;
(i) a rear part having a pair of extension arms; and
(m) a cylindrical bar perpendicular to the extension arms.

7. The articulator of claim 6, wherein the surrounding wall is provided with pin number indicators.

8. The articulator of claim 6, wherein the removal of the wall upon completion of the model work breaks off and removes all excess stone, producing a clean dental model that does not need to be trimmed or ground.

9. The method of modeling dental impressions in stone and mounting said dental models in an articulator to correlate the models throughout a full range of occlusal and masticatory movement, said method consisting of the sequential steps of:
(a) determining pin holes and placing the die pins by means of a custom-fabricated fixture;
(b) mixing the dental stone, pouring the stone into the lower part and the impression tray, and placing the impression tray upside down against the tray positioning plates on top of the lower part and allowing the model stone to harden, whereupon the impression tray is removed and a lower dental model is formed;
(c) removing the detachable walls by cutting and pulling out the rear walls;
(d) preparing an opposing model in the conventional way;
(e) placing the upper dental model on the lower dental model in proper occlusion;
(f) connecting a rear part to the lower part with the dental model by pivotally joining them together;
(g) drop inserting an upper part to the rear part and fixing with an adhesive;
(h) applying an adhesive to the hole at the center of the spherical concave of the upper part to attach the upper dental model to the upper part; and
(i) mixing and applying the plaster over the upper dental model and the upper part and allowing the plaster to harden, whereupon the model work is completed.

10. An articulator with a fixed wall and a tray positioning plate for correlating the upper and lower dental models corresponding to the upper and lower sets of a patient's teeth, the said articulator comprising:
(a) a lower part comprising a full arch box with an open bottom;
(b) a horse-shoe shape block with embedded pin holes housed in the middle of the lower part;
(c) a pair of tray positioning plates at the rear end of the full arch box of the lower part;
(d) a surrounding fixed wall attached to the full arch box of the lower part;
(e) two rows of struts along the wall;
(f) an incisal guide plate extending from one end of the lower part;
(g) a pair of hinge assemblies extending from the opposite end of the lower part and incorporating the horizontal and lateral condylar guides;
(h) an upper part comprising a spherical inner surface;
(i) a spherically concaved area with a hole at the center and a box with an open top;
(j) a vertical support with half cylindrical sides extending down from one end of said upper part;
(k) an incisal pin hole at the opposite end of said upper part;
(l) a rear part having a pair of extension arms; and
(m) a cylindrical bar perpendicular to the extension arms.

11. The articulator of claim 10, wherein the surrounding wall is provided with pin number indicators.

12. The method of modeling dental impressions in stone and mounting said dental models in an articulator to correlate the models throughout a full range of occlusal and masticatory movement, said method consisting of the sequential steps of:
(a) determining pin holes and placing the die pins by means of a custom-fabricated fixture;
(b) mixing the dental stone, pouring the stone into the lower part and the impression tray, and placing the impression tray upside down against the tray positioning plates on top of the lower part and allowing the model stone to harden, whereupon the impression tray is removed and a lower dental model is formed;
(c) cutting and removing the tray positioning plates, upon which the dental model becomes removable;
(d) preparing an opposing model in a conventional method;
(e) placing the upper dental model on the lower dental model in proper occlusion;
(f) connecting a rear part to the lower part with the dental model by pivotally joining them together;
(g) drop inserting an upper part to the rear part and fixing with an adhesive;
(h) applying an adhesive to the hole at the center of the spherical concave of the upper part to attach the upper dental model to the upper part; and
(i) mixing and applying the plaster over the upper dental model and the upper part and allowing the plaster to harden, whereupon the model work is completed.

13. An articulator with a removable wall and a tray positioning plate for correlating the upper and lower dental models corresponding to the upper and lower sets of a patient's teeth, the said articulator comprising:
(a) a lower part having a box with an open bottom;
(b) an elongated block with pin holes on the lower part;
(c) two rows of struts and retentive latches on said lower part;
(d) a platform extending from one end of the lower part;
(e) a L-shaped bracket extending from the opposite end of the lower part and incorporating a male hinge assembly for interconnecting said male hinge assembly with an opposing female hinge assembly;
(f) an upper part having upper and lower surfaces and having a flat channeled surface provided with an elongated open slot in the middle of the top surface;
(g) a resiliently deformable bracket extending from one end of said upper part;
(h) a platform with a hole extending from the opposite end of said upper part;
(i) a female hinge assembly on the other end of said upper part;
(j) a middle part having pin number indicators, a tray positioning plate, and a pair of male latches; and
(k) undercut edges formed in the lower edge of said middle part adapted to receive a prying tool, which is used to lift and separate the middle part from the lower part.

14. The articulator of claim 13, wherein the depth of the elongated block in the lower part is slightly more shallow than the length of the pins, thereby exposing the distal end portions of the pins, and means on the underside of said lower part projecting below the distal end portions of the pins whereby when the articulator is supported on a work bench the pins are spaced from the work bench.

15. The articulator of claim 13, wherein said male hinge assembly includes a rod extending transverse to said upper part and forms a pivotal axis enabling selective relative pivotal displacement of said upper and lower parts.

16. The method of modeling dental impressions in stone and mounting said dental models in an articulator to correlate the models throughout a full range of occlusal and masticatory movement, said method consisting of the sequential steps of:
(a) assembling an articulator by pivotally joining an upper part to a lower part in vertically spaced relation and seating a middle part on top of the lower part spaced from the upper part;
(b) placing the impression tray over the lower part, making the tray-end touch the tray positioning plate;
(c) determining the pin hole numbers and placing die pins in the holes;
(d) pouring a mixed dental stone into the die side of the impression tray and placing it upside down on top of the lower part, making the tray-end touch the tray positioning plate, and allowing the model stone to harden, whereupon the articulator is opened;
(e) pouring a mixed dental stone into the opposing side of the impression tray, closing the articulator and allowing the model stone to harden, whereupon the articulator is opened;
(f) removing the impression tray from the opened articulator;
(g) separating the middle part and the dental model together from the lower part with the fingers;
(h) removing the middle part from the dental model with the fingers; and
(i) returning the dental model to its original position in the lower part, whereupon the model work is completed.
